(19) United States
(12) Patent Application Publication
(10) Pub. No.: US 2004/0052347 A1
(43) Pub. Date: Mar. 18, 2004

(54) Gateway card, gateway device, gateway control method, and computer product

(75) Inventors: Masatoshi Kimura, Kawasaki (JP); Katsuyuki Nonaka, Kawasaki (JP); Shuichi Suzuki, Kawasaki (JP); Shigeo Sakuma, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/658,341

(22) Filed: Sep. 10, 2003

(30) Foreign Application Priority Data
Sep. 13, 2002 (JP) 2002-269258

(51) Int. Cl. H04M 11/00

(52) U.S. Cl. 379/102.01; 379/102.03

(57) ABSTRACT

Various home appliances are connected to a gateway card. The gateway card receives a remote control request and remote control data from a remote client. The apparatus to be remote controlled is identified from the remote control request. When remote control request is received, the gateway card receives the changes the power mode of the personal computer from power-saving operation mode to a normal operation mode, sets the remote control data to the apparatus to be remote controlled, notifies the client of completion of the data setting, and changes the power mode of the personal computer from the normal operation mode to the power-saving operation mode.

### BACKGROUND OF THE INVENTION

1) Field of the Invention

The present invention relates to a gateway card for adjusting communication protocols between different networks using remote control.

2) Description of the Related Art

Recently, not only personal computers, but also home appliances such as the televisions and telephones, have been equipped with the Internet connection function that makes it possible to connect these home appliances to the Internet.

When a user purchases such an apparatus, it is required to do settings so that the apparatus can be connected to an access point of the Internet. These settings generally take lot of time and are tedious. Moreover, it is necessary to connect these apparatuses to telephone lines, to computers etc. These connections are generally complex and troublesome.

A gateway device called a home gateway or the like has attracted attention in recent years. What this device does is that it adjusts differences in communication protocols between the network at home and external networks including the Internet.

Precisely, all the devices in the home that have the Internet connection function are connected to this gateway device and the gateway device is connected to the public telephone line or other network. All the devices connected to the gateway device can be connected to the Internet so that tedious settings or complex wiring is not required.

A remote control system that remote controls home appliances such as a video recorder via the Internet and the gateway apparatus, has been proposed.

This type of remote control system has been disclosed in the Japanese Patent Application Laid-Open Nos. 2002-78036, 2001-95067, 2002-77274, and 2001-53779.

When such gateway devices are to be used in the offices, reliability of the gateway device is given priority over its power consumption. However, when such gateway devices are to be used at homes, the power consumption is given priority over the reliability.

### SUMMARY OF THE INVENTION

It is an object of the invention to at least solve the problems in the conventional technology.

A gateway card according to one aspect of the present invention is connected to an information processor and receives and transmits data between different networks. This gateway card includes a receiving unit that receives from a remote control device remote control data to be set to an apparatus to be remote controlled and a remote control request; a data setting unit that makes the information processor set the remote control data to the apparatus to be remote controlled; and a power control unit that changes a power mode of the information processor from a power-saving mode to a normal power mode when the receiving unit receives the remote control request, and changes the power mode from the normal power mode to the power-saving mode when the setting of in the remote control data to apparatus to be remote controlled is complete.

A gateway control method according to another aspect of the present invention is applied to a gateway card that is connected to an information processor and that receives and transmits data between different networks. This gateway control method includes receiving from a remote control device remote control data to be set to an apparatus to be remote controlled and a remote control request; shifting a power mode of the information processor from a power-saving mode to a normal power mode upon reception of the remote control request; making the information processor set the remote control data to the apparatus to be remote controlled; and shifting the power mode of the information processor from the normal power mode to the power-saving mode, when the setting of in the remote control data to apparatus to be remote controlled is complete.

A gateway apparatus according to still another aspect of the present invention has an information processor and a gateway section that is connected to the information processor and that receives and transmits data between different networks. The gateway section includes a receiving unit that receives from a remote control device remote control data to be set to an apparatus to be remote controlled and a remote control request; a returning unit that issues a return notification to return a power mode of the information processor from a power-saving mode to a normal power mode when the receiving unit receives the remote control request; a data setting unit that makes the information processor set the remote control data to the apparatus to be remote controlled; and a changing unit that issues a shift notification to change the power mode of the information processor from the normal power mode to the power-saving mode when the setting of in the remote control data to apparatus to be remote controlled is complete. The information processor includes a power control unit that returns the power mode of the information processor from the power-saving mode to the normal power mode based on the return notification, and changes the power mode of the information processor from the normal power mode to the power-saving mode based on the shift notification.

A gateway control method according to still another aspect of the present invention is applied to a gateway apparatus that has an information processor and a gateway section that is connected to the information processor and that receives and transmits data between different networks. The gateway section executes receiving from a remote control device remote control data to be set to an apparatus to be remote controlled and a remote control request; issuing a return notification to return a power mode of the information processor from a power-saving mode to a normal power mode when the remote control request is received; making the information processor set the remote control data to the apparatus to be remote controlled; and issuing a shift notification to change the power mode of the information processor from the normal power mode to the power-saving mode, when the setting of in the remote control data to apparatus to be remote controlled is complete. The information processor executes returning the power mode of the information processor from the power-saving mode to the normal power mode based on the return notification, and changing the power mode of the information processor from the normal power mode to the power-saving mode based on the shift notification.

Computer programs according to still other aspects of the present invention execute the methods according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of a structure of a remote control system according to one embodiment of the present invention;

FIG. 2 is a block diagram of a detailed structure of a switching section 517 shown in FIG. 1;

FIG. 3 is a sequence diagram of power mode shift operation.

FIG. 4 is a sequence diagram of a remote control operation according to the embodiment;

FIGS. 5A to 5C show various kinds of screens according to the embodiment; and

FIG. 6 is a block diagram of a structure of a modification of the embodiment.

### DETAILED DESCRIPTION

Exemplary embodiments of the gateway card, the gateway apparatus, the gateway control method, and the computer program relating to the present invention will be explained in detail below with reference to the accompanying drawings.

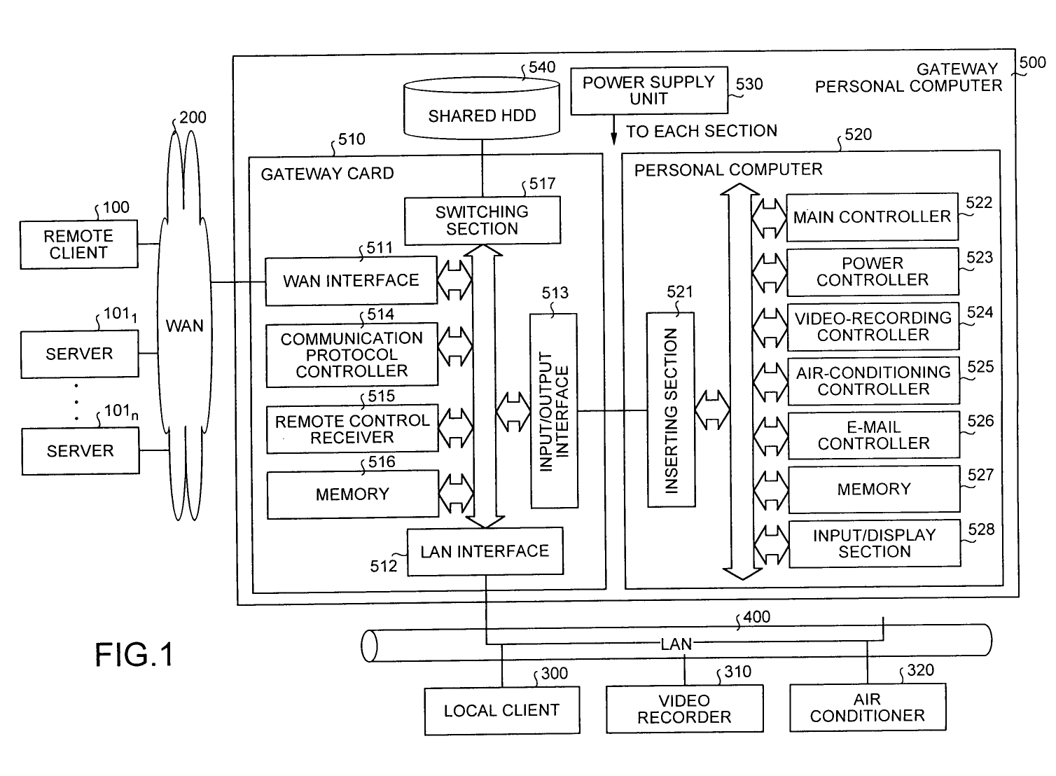

FIG. 1 is a block diagram of a structure of a remote control system according to an embodiment of the present invention. FIG. 1 illustrates a remote control system in which a Wide Area Network (WAN) 200 and a Local Area Network (LAN) 400, having mutually different communication protocols and different standards, are connected to each other via a gateway personal computer 500. The remote control system enables a remote client 100 or a local client 300 to remote control a video recorder 310 or an air conditioner 320.

The WAN 200 is a network such as the Internet, a public line network, a radio communication network, a CATV (CAble TeleVision) network, and the like. The WAN 200 interconnects remote computers to each other according to predetermined, mutually different communication protocols. The WAN 200 will be explained by taking the Internet as an example.

The remote client 100 is a computer (such as a desktop personal computer, a notebook personal computer, a Personal Digital Assistant (PDA), and a portable terminal) that is connected to the WAN 200. The remote client 100 works as a remote control apparatus that remote controls apparatus such as the video recorder 310 and the air conditioner 320, as described later.

The remote client 100 records a television program and the like into the video recorder 310, as set in advance. The remote client 100 also sets a mode of operation and conditions such as air temperature and wind level, in the air conditioner 320.

Servers 100₁ to 100ₙ are connected to the WAN 200. The servers 100₁ to 100ₙ are, for example, mail servers, WWW (World Wide Web) servers, and the like. The servers 100₁ to 100ₙ provide mail services and WWW site services, and the like to the local client 300 and the like via the WAN 200, the gateway personal computer 500, and the LAN 400.

The local client 300 (such as a desktop personal computer, and a notebook personal computer) is connected to the LAN 400 laid down at home. Like the remote client 100, the local client 300 works as a remote control apparatus that remote controls apparatuses such as the video recorder 310 and the air conditioner 320.

In other words, the remote client 100 and the local client 300 can remotely control home apparatuses.

The local client 300 also has a function of receiving various kinds of services by accessing the servers 1001 to 100n via the LAN 400, a gateway card 510, and the WAN 200.

The video recorder 310 is connected to the LAN 400, and records television programs and the like. The remote client 100 or the local client 300 remote controls the setting of the programs to be recorded in this video recorder 310 as one of the apparatuses to be remote controlled.

The air conditioner 320 is also connected to the LAN 400 like the video recorder 310, and carries out room air conditioning. The remote client 100 or the local client 300 remote controls the settings in this air conditioner 320 as one of the apparatuses to be remote controlled.

The gateway personal computer 500 is installed at home and is exclusively used to provide functions of a gateway such as a router function and a bridge function, and, additionally, a remote control function. The gateway is a general term of hardware and software that make it possible to interconnect between the WAN 200 and the LAN 400 by adjusting a difference between the communication protocols of these networks. The remote control function is the function of remote controlling the apparatuses such as the video recorder 310 and the air conditioner 320.

The gateway personal computer 500 includes the gateway card 510, a personal computer 520, a power supply unit 530, and a common HDD (Hard Disk Drive) 540.

The gateway card 510 is a card-type gateway device that can be detachably inserted into an inserting section 521 of the personal computer 520. This gateway card 510 provides the functions of the gateway and the remote control function.

The personal computer 520 is a general personal computer and a remote control unit. The power supply unit 530 supplies power to each section of the gateway card 510 and the personal computer 520.

The common HDD 540 is a large-capacity memory that is shared by the gateway card 510 and the personal computer 520. This common HDD 540 stores, for example, the operating systems and the application programs that are used in the gateway card 510 and the personal computer 520 respectively. A switching section 517 executes a switching of the common HDD 540.

Various kinds of application programs are stored in the common HDD 540. Of these, the application programs used in the personal computer 520 include a resident application program, a power control program, a video-recording control program, an air-conditioning control program, and an e-mail control program.

The resident application program is a computer program that implements functions of a main controller 522 to be described later. The power control program is a computer program that implements functions of a power controller 523.

The recording control program is a computer program that implements functions of a video-recording controller 524. The air-conditioning control program is a computer program that implements functions of an air-conditioning controller 525. The e-mail control program is a computer program that implements functions of an e-mail controller 526.

The gateway card 510 has a WAN interface section 511 that is connected to the WAN 200. The WAN interface section 511 functions as a communication interface with the WAN 200. Similarly, the gateway card 510 has a LAN interface section 512 that is connected to the LAN 400. The LAN interface section 512 functions as a communication interface with the LAN 400.

The gateway card 510 has an input/output interface section 513 that is detachably inserted into the insertion section 521 of the personal computer 520. The input/output interface section 513 functions as an interface with the personal computer 520.

The gateway card 510 has a communication protocol controller 514 that carries out a control to adjust a difference between the communication protocols of the WAN 200 and the LAN 400. That is, the communication protocol controller 514 performs the analysis of communication protocols of the WAN 200 and the LAN 400 to make the interconnection possible.

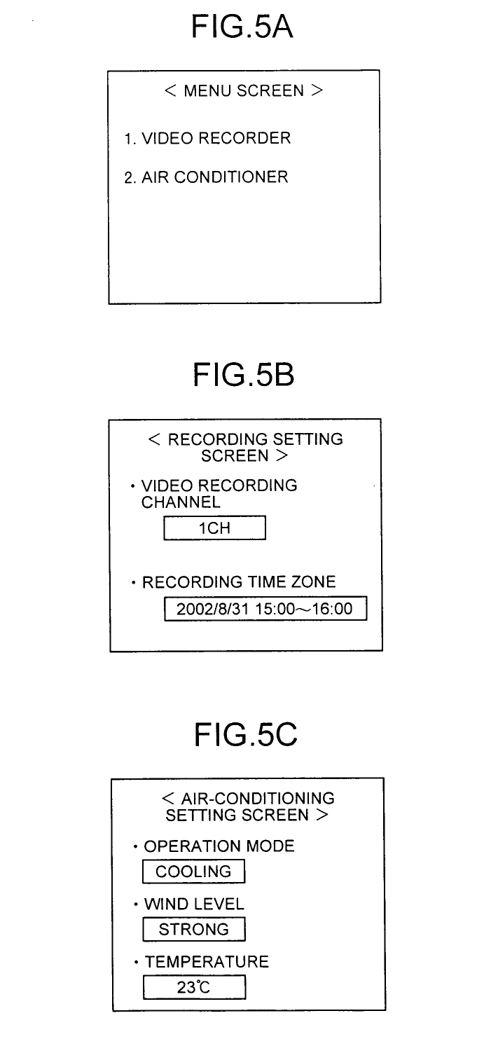

The gateway card 510 has a remote control receiver 515 that receives a remote control instructions from the remote client 100 or the local client 300 based on various kinds of screens (see FIG. 5A to FIG. 5C).

A menu screen illustrated in FIG. 5A is used to select any one of the apparatuses to be remote controlled, that is, either the video recorder 310 or the air conditioner 320. A recording setting screen illustrated in FIG. 5B is used to set data corresponding to the video recorder 310, such as a video recording channel, and a video recording time zone.

An air-conditioning setting screen illustrated in FIG. 5C is used to set data corresponding to the air conditioner 320, such as an operation mode, a wind level, and a temperature.

Referring back to FIG. 1, the gateway card 510 has a memory 516 that is a rewritable read-only memory that requires no back-up power supply and can electrically erase stored data. This memory 516 is a flash EPROM (Erasable Programmable Read Only Memory) or the like. This memory 516 stores system data and other data. When the gateway card 510 provides functions of a router, for example, the system data includes an IP (Internet Protocol) address, DHCP (Dynamic Host Configuration Protocol) data, line data, filtering data, and firmware.

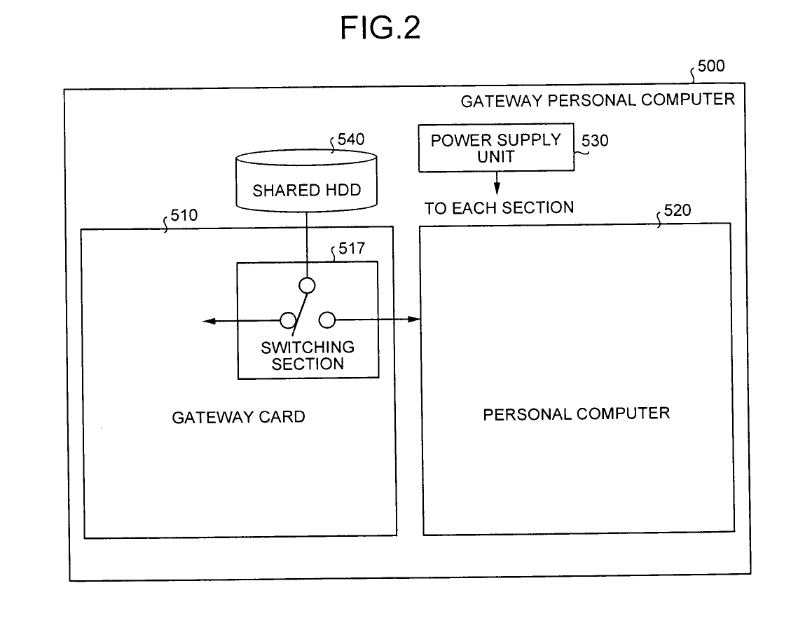

FIG. 2 shows the detail structure of the switching section 517. This switching section 517 can connect the common HDD 540 to the gateway card 510 or to the personal computer 520. When the switching section 517 connects the gateway card 510 to the common HDD 540, the gateway card 510 can access the common HDD 540. On the other hand, when the switching section 517 connects the gateway card 510 to the personal computer 520, the personal computer 520 can access the common HDD 540.

The gateway card 510 assigns specific addresses to be able to distinguish between the remote client 100 and the local client 300.

Referring back to FIG. 1, the personal computer 520 has an inserting section 521, into which the input/output interface 513 of the gateway card 510 is inserted. The personal computer 520 has a main controller 522 that controls operation of every section of the personal computer 520. The personal computer 520 has a power controller 523 that can set the operation of the personal computer 520 in a normal operation mode or a power-saving operation mode. A power supply unit 530 supplies power to every section of the personal computer 520 based on the mode set by the power controller 523.

The normal operation mode means that a rated power is supplied to each section of the personal computer 520. The power-saving operation mode means that a minimum necessary power (which is lower than the rated power) is supplied to every section of the personal computer 520. Since low power is supplied in the power-saving operation mode, it is possible to save power and reduce the electric bill in the power-saving operation mode.

The power-saving operation mode is classified into a standby mode and a suspension mode. In the standby mode, a memory 527 in the personal computer 520 stores the work data and, therefore, it is necessary to keep supplying power to this memory 527. On the other hand, in the suspension mode, the common HDD 540 stores the work data, and power supply to this common HDD 540 is set off. Thus, in the standby mode there is no need to supply power to the personal computer 520. As a result, power consumption in the suspension mode is much smaller than that in the standby mode.

The power controller 523 carries out a control of shifting the power mode from a normal operation mode to a power-saving operation mode when a shift factor occurred, and returning the power mode from the power-saving operation mode to the normal operation mode when a return factor occurred.

The shift factor includes an end of a remote-control operation in the personal computer 520. On the other hand, the return factor includes a return request from the gateway card 510.

The personal computer 520 has a video-recording controller 524 that sets the remote control data input in the recording setting screen (see FIG. 5B), to the video recorder 310. The air-conditioning controller 525 sets the remote control data input in the air-conditioning setting screen (see FIG. 5C), to the air conditioner 320.

The e-mail controller 526 prepares a completion e-mail to indicate that the video-recording controller 524 or the air-conditioning controller 525 has completed the remote control settings, and hands over this completion e-mail to the gateway card 510.

The memory 527 stores various kinds of data. An input/display section 528 includes a keyboard and a mouse used to input various kinds of data. The input/display section 528 further includes a CRT (Cathode Ray Tube) or an LCD (Liquid Crystal Display) that displays screens and data.

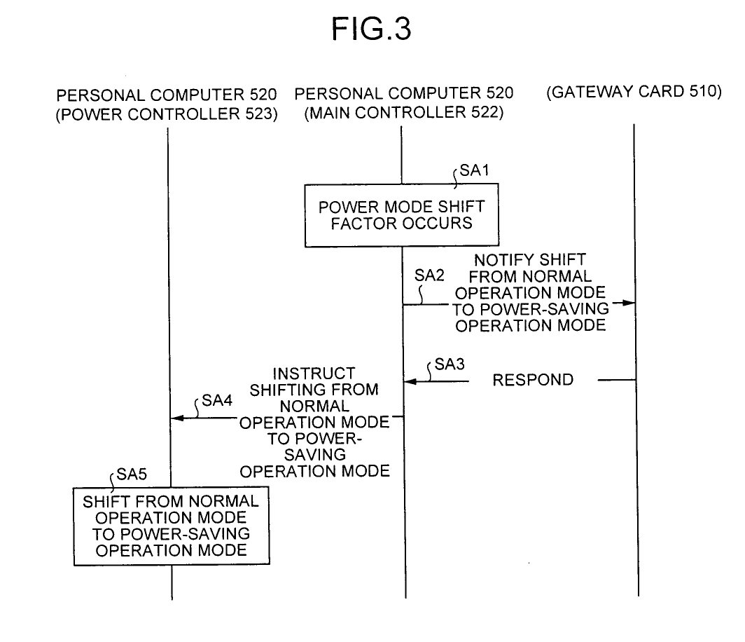

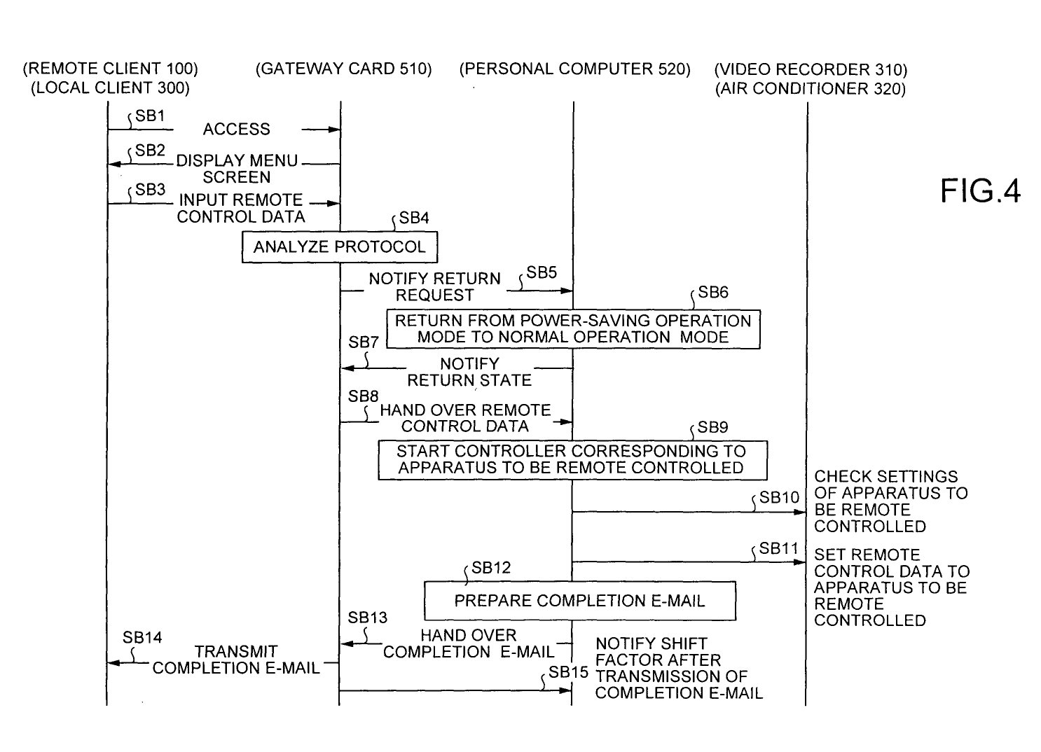

Power mode shift operation and power control operation according to one embodiment of the present invention will be explained with reference to sequence diagrams illustrated in FIG. 3 and FIG. 4. FIG. 3 is a sequence diagram that explains power mode shift operation according to one embodiment. FIG. 4 is sequence diagrams that explain remote control operation in the embodiment.

When the power mode of the personal computer 520 is the normal operation mode and the power mode shift factor occurs at step SA1 (see FIG. 3), the main controller 522 of the personal computer 520 notifies the gateway card 510 of a shift from the normal operation mode to a power-saving operation mode at step SA2.

At step SA3, the communication protocol controller 514 of the gateway card 510 notifies a response to the main controller 522 of the personal computer 520 to confirm the shift notice.

At step SA4, the main controller 522 instructs the power controller 523 to shift the power mode from the normal operation mode to the power-saving operation mode. At step SA5, the power controller 523 shifts the power mode from the normal operation mode to the power-saving operation mode. As a result, the personal computer 520 can decrease power consumption.

Assume that the power mode of the personal computer 520 is the power-saving operation mode. In this state, at step SB1 illustrated in FIG. 4, the remote client 100 or the local client 300 accesses the gateway card 510 via the WAN 200 or the LAN 400, in order to execute a remote control.

At step SB2, the remote control receiver 515 of the gateway card 510 instructs the display section of the remote client 100 to display the menu screen (see FIG. 5A).

At step SB3, the user at the remote client 100 selects an apparatus to be remote controlled from the menu screen A, and inputs remote control data on the recording setting screen B or the air-conditioning setting screen C. As an example, assume that the user selects the video recorder 310 as the apparatus to be remote controlled, and inputs the remote control data on the recording setting screen B.

At step SB4, the remote control receiver 515 analyzes the protocol relating to the input remote control data (see FIG. 5B). The input remote control data includes specific address that are assigned in advance, and that corresponds to the apparatus to be remote controlled. By analyzing the protocol, the remote control receiver 515 determines the apparatus to be remote controlled, that is, the video recorder 310, in this example.

At step SB5, the remote control receiver 515 notifies the power controller 523 of the personal computer 520 of a request to return the power mode of the personal computer 520 from the power-saving operation mode to the normal operation mode.

At step SB6, the power controller 523 returns the power mode from the power-saving operation mode to the normal operation mode. As a result, rated power is supplied to each section of the personal computer 520, so that the personal computer 520 wakes up.

At step SB7, the power controller 523 notifies the gateway card 510 of the return to normal operation mode. At step SB8, the remote control receiver 515 hands over to the main controller 522 of the personal computer 520, the remote control data (refer to FIG. 5B) input at step SB3 together with the result of the protocol analysis at step SB4.

At step SB9, the main controller 522 starts the video-recording controller 524 corresponding to the the video recorder 310 (the apparatus to be remote controlled in this example) based on the remote control data, and hands over the remote control data to the video-recording controller 524. Similarly, if the air conditioner 320 is the apparatus to be remote controlled, the main controller 522 starts the air-conditioning controller 525, and hands over the remote control data to the air-conditioning controller 525.

At step SB10, the video-recording controller 524 accesses the video recorder 310 (the apparatus to be remote controlled in this example) via the gateway card 510 and the LAN 400, to verify that the same remote control data has not already been set. If the same remote control data has already been set to the video recorder 310, the series of remote control operation is interrupted, and an error occurs.

At step SB11, the video-recording controller 524 accesses the video recorder 310 (the apparatus to be remote controlled in this example) via the gateway card 510 and the LAN 400, and sets the remote control data (refer to FIG. 5B). As a result, the required recording settings in the video recorder 310 are done based on the remote control data.

At step SB12, The e-mail controller 526 prepares the completion e-mail to indicate that the video recorder 310 (the apparatus to be remote controlled in this example) has completed the setting of the remote control data. At step SB13, The e-mail controller 526 hands over the prepared completion e-mail to the gateway card 510 via the inserting section 521 and the input/output interface 513.

At step SB14, the communication protocol controller 514 of the gateway card 510 transmits the completion e-mail to the remote client 100 via the WAN 200.

After the transmission of the completion e-mail, at step SB15, the remote control receiver 515 notifies the personal computer 520 of a shift factor (end of the access) to shift the power mode from the normal operation mode to the power-saving operation mode.

As a result, at step SA1 illustrated in FIG. 3, the shift factor of the power mode in the personal computer 520 occurs. The processing at steps SA2 to SA5 is executed subsequently, and the power mode of the personal computer 520 is shifted from the normal operation mode to the power-saving operation mode.

As explained above, according to the present embodiment, the remote client 100 or the local client 300 as the remote-control device issues a remote control request. In response to this request, the gateway card 510 instructs the personal computer 520 to return the power mode from the power-saving operation mode to the normal operation mode, and sets the remote control data to the apparatus to be remote controlled (i.e., the video recorder 310 or the air conditioner 320). After completion of the setting, the gateway card 510 shifts the power mode from the normal operation mode to the power-saving operation mode. Therefore, it is possible to reduce the power consumption when there is a plurality of apparatuses that can be remote controlled.

When the setting of the remote control data is completed, the completion e-mail is prepared by the personal computer 520. This completion mail is transmitted to the remote client 100 or the local client 300. Therefore, it is possible to notify the user of the completion of the setting, which increases the convenience of the user.

The remote control receiver 515 of the gateway card 510 determines one of a plurality of apparatuses to be remote controlled (the video recorder 310 and the air conditioner 320), by analyzing the remote control data. The remote control receiver 515 sets the remote control data to the apparatus to be remote controlled. Therefore, it is possible to reduce the power consumption when there is a plurality of apparatuses that can be remote controlled.

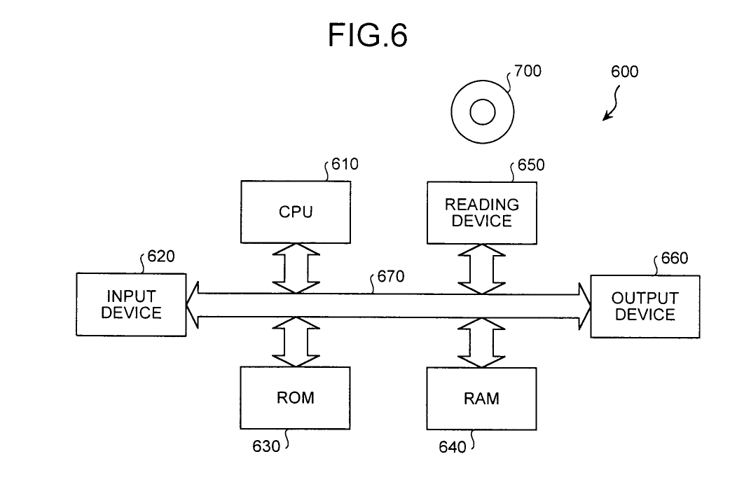

A computer program for realizing the functions of the gateway personal computer (the gateway card 510, and the personal computer 520) may be recorded on a computer-readable recording medium 700 illustrated in FIG. 6. A computer 600 illustrated in this drawing may read the program recorded on the recording medium 700, and execute the program to realize the functions.

The computer 600 includes a CPU (Central Processing Unit) 610 that executes the program, an input device 620 such as a keyboard and a mouse, a ROM (Read Only Memory) 630 that stores various kinds of data, a RAM (Random Access Memory) 640 that stores operation parameters, a reading device 650 that reads the program from the recording medium 700, an output device 660 such as a display and a printer, and a bus 670 that connects between the devices.

The CPU 610 reads the program recorded on the recording medium 700, via the reading device 650, and executes the program, thereby to realize the above functions. An optical disk, a flexible disk, and a hard disk may be used as the recording medium 700.

As explained above, according to one aspect of the present invention, it is possible to reduce the power consumption when there is a plurality of apparatuses that are to be remote controlled.

Moreover, it is possible to notify the user of the completion of the setting, which makes the apparatus convenient to use.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A gateway card that is connected to an information processor and that receives and transmits data between different networks, the gateway card comprising:
a receiving unit that receives from a remote control device remote control data to be set to an apparatus to be remote controlled and a remote control request;
a data setting unit that makes the information processor set the remote control data to the apparatus to be remote controlled; and
a power control unit that changes a power mode of the information processor from a power-saving mode to a normal power mode when the receiving unit receives the remote control request, and changes the power mode from the normal power mode to the power-saving mode when the setting of in the remote control data to apparatus to be remote controlled is complete.

2. The gateway card according to claim 1, further comprising an e-mail unit that receives a completion e-mail, which indicates that the setting of in the remote control data to apparatus to be remote controlled is complete, from the information processor, and that transmits the completion e-mail to the remote control device, whereby an operator of the remote control device knows that the setting of in the remote control data to apparatus to be remote controlled is complete.

3. The gateway card according to claim 1, wherein the data setting unit identifies one apparatus to be remote controlled from among a plurality of apparatuses from information contained in the remote control data, and makes the information processor set the remote control data to the identified apparatus.

4. A gateway control method applied to a gateway card that is connected to an information processor and that receives and transmits data between different networks, the gateway control method comprising:
receiving from a remote control device remote control data to be set to an apparatus to be remote controlled and a remote control request;
shifting a power mode of the information processor from a power-saving mode to a normal power mode upon reception of the remote control request;
making the information processor set the remote control data to the apparatus to be remote controlled; and
shifting the power mode of the information processor from the normal power mode to the power-saving mode, when the setting of in the remote control data to apparatus to be remote controlled is complete.

5. The gateway control method according to claim 4, further comprising receiving a completion e-mail, which indicates that the setting of in the remote control data to apparatus to be remote controlled is complete, from the information processor, and transmitting the completion e-mail to the remote control device, whereby an operator of the remote control device knows that the setting of in the remote control data to apparatus to be remote controlled is complete.

6. The gateway control method according to claim 4, further comprising identifying one apparatus to be remote controlled from among a plurality of apparatuses from information contained in the remote control data, and making the information processor set the remote control data to the identified apparatus.

7. A computer program that is applied to a gateway card that is connected to an information processor and that receives and transmits data between different networks, the computer program making a computer execute:
receiving from a remote control device remote control data to be set to an apparatus to be remote controlled and a remote control request;
shifting a power mode of the information processor from a power-saving mode to a normal power mode upon reception of the remote control request;
making the information processor set the remote control data to the apparatus to be remote controlled; and
shifting the power mode of the information processor from the normal power mode to the power-saving mode, when the setting of in the remote control data to apparatus to be remote controlled is complete.

8. The computer program according to claim 7, further making the computer execute receiving a completion e-mail, which indicates that the setting of in the remote control data to apparatus to be remote controlled is complete, from the information processor, and transmitting the completion e-mail to the remote control device, whereby an operator of the remote control device knows that the setting of in the remote control data to apparatus to be remote controlled is complete.

9. The computer program according to claim 7, further making the computer execute identifying one apparatus to be remote controlled from among a plurality of apparatuses from information contained in the remote control data, and making the information processor set the remote control data to the identified apparatus.

10. A gateway apparatus having an information processor and a gateway section that is connected to the information processor and that receives and transmits data between different networks, wherein
the gateway section includes
a receiving unit that receives from a remote control device remote control data to be set to an apparatus to be remote controlled and a remote control request;
a returning unit that issues a return notification to return a power mode of the information processor from a power-saving mode to a normal power mode when the receiving unit receives the remote control request;
a data setting unit that makes the information processor set the remote control data to the apparatus to be remote controlled; and
a changing unit that issues a shift notification to change the power mode of the information processor from the normal power mode to the power-saving mode when the setting of in the remote control data to apparatus to be remote controlled is complete, and
the information processor includes a power control unit that returns the power mode of the information processor from the power-saving mode to the normal power mode based on the return notification, and changes the power mode of the information processor from the normal power mode to the power-saving mode based on the shift notification.

11. The gateway apparatus according to claim 10, further comprising an e-mail unit that receives a completion e-mail, which indicates that the setting of in the remote control data to apparatus to be remote controlled is complete, from the information processor, and that transmits the completion e-mail to the remote control device, whereby an operator of the remote control device knows that the setting of in the remote control data to apparatus to be remote controlled is complete.

12. The gateway apparatus according to claim 10, wherein the data setting unit identifies one apparatus to be remote controlled from among a plurality of apparatuses based on the remote control data, and makes the information processor set the remote control data to the identified apparatus.

13. A gateway control method applied to a gateway apparatus that has an information processor and a gateway section that is connected to the information processor and that receives and transmits data between different networks, wherein
the gateway section executes
receiving from a remote control device remote control data to be set to an apparatus to be remote controlled and a remote control request;
issuing a return notification to return a power mode of the information processor from a power-saving mode to a normal power mode when the remote control request is received;
making the information processor set the remote control data to the apparatus to be remote controlled; and
issuing a shift notification to change the power mode of the information processor from the normal power mode to the power-saving mode, when the setting of in the remote control data to apparatus to be remote controlled is complete, and
the information processor executes returning the power mode of the information processor from the power-saving mode to the normal power mode based on the return notification, and changing the power mode of the information processor from the normal power mode to the power-saving mode based on the shift notification.

14. The gateway control method according to claim 13, further comprising receiving a completion e-mail, which indicates that the setting of in the remote control data to apparatus to be remote controlled is complete, from the information processor, and transmitting the completion e-mail to the remote control device, whereby an operator of the remote control device knows that the setting of in the remote control data to apparatus to be remote controlled is complete.

15. The gateway control method according to claim 13, further comprising identifying one apparatus to be remote controlled from among a plurality of apparatuses from information contained in the remote control data, and making the information processor set the remote control data to the identified apparatus.

16. A computer program applied to a gateway apparatus that has an information processor and a gateway section that is connected to the information processor and that receives and transmits data between different networks, wherein the computer program makes
the gateway section execute
receiving from a remote control device remote control data to be set to an apparatus to be remote controlled and a remote control request;
issuing a return notification to return a power mode of the information processor from a power-saving mode to a normal power mode when the remote control request is received;
making the information processor set the remote control data to the apparatus to be remote controlled; and
issuing a shift notification to change the power mode of the information processor from the normal power mode to the power-saving mode, when the setting of in the remote control data to apparatus to be remote controlled is complete, and
the information processor execute returning the power mode of the information processor from the power-saving mode to the normal power mode based on the return notification, and changing the power mode of the information processor from the normal power mode to the power-saving mode based on the shift notification.

17. The computer program according to claim 16, further making the computer execute receiving a completion e-mail, which indicates that the setting of in the remote control data to apparatus to be remote controlled is complete, from the information processor, and transmitting the completion e-mail to the remote control device, whereby an operator of the remote control device knows that the setting of in the remote control data to apparatus to be remote controlled is complete.

18. The computer program according to claim 16, further making the computer execute identifying one apparatus to be remote controlled from among a plurality of apparatuses from information contained in the remote control data, and making the information processor set the remote control data to the identified apparatus.
